(19) United States
(12) Patent Application Publication
(10) Pub. No.: US 2004/0070116 A1
(43) Pub. Date: Apr. 15, 2004

(54) Method and device for producing a shaped body

(76) Inventors: Alfred Kaiser, Fohren (DE); Stefan Mahler, Hetzerath (DE); Robert Kremer, Aachen (DE); Klaus Muller, Welschbillig (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/468,505

(22) PCT Filed: Feb. 11, 2002
(86) PCT No.: PCT/IB02/00466

(30) Foreign Application Priority Data
Feb. 22, 2001 (DE) 101 08 570.2

(51) Int. Cl. B29B 13/00

(52) U.S. Cl. 264/404; 264/405; 425/174

(57) ABSTRACT

The invention concerns a process for producing a molded body, in which a preferably powdered, pasty, or granular molding material is heated and compressed in a pressing cavity, and the molding material is heated by producing ohmic heat in it.

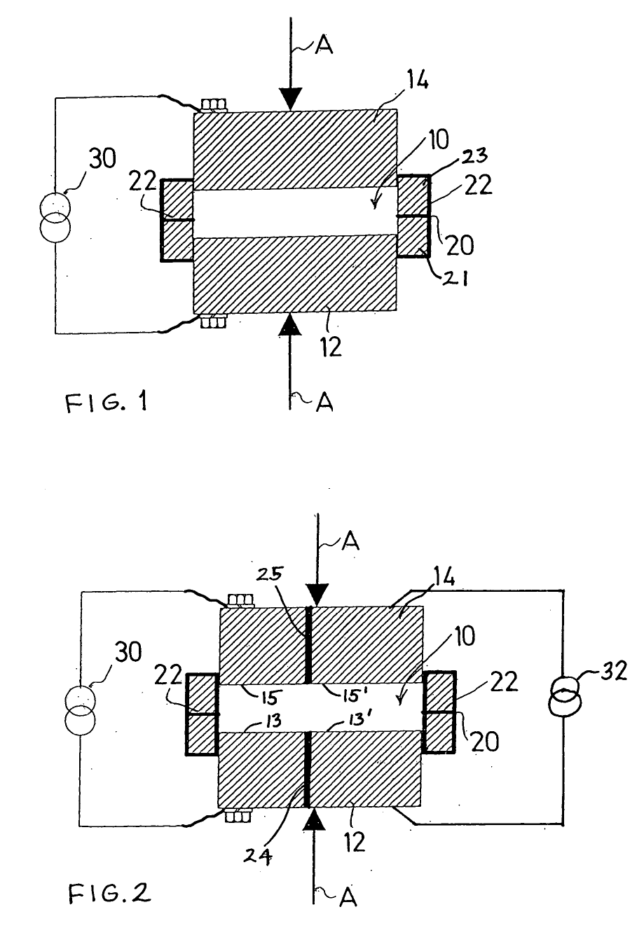

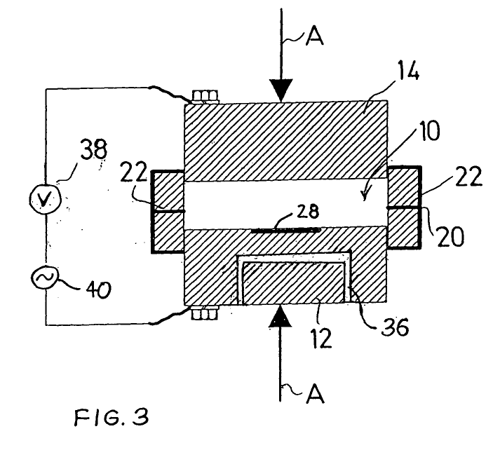

The invention concerns a process for producing a molded body, in which a preferably powdered, pasty, or granular molding material is heated and compressed in a pressing cavity, and equipment that can be used to carry out processes of this type.

Processes of the above type are used, for example, to produce plate-shaped or block-shaped products from a powdered, pasty, or granular starting material. They are usually carried out with so-called uniaxial presses, in which the pressing cavity is bounded by a press frame and a molding die and two press rams that move into this molding die in opposite directions from each other, such that the pressing pressure required to produce the molded body is applied by the colliding pressing rams. In this regard, cohesion of the usually powdered molding material in the course of the compression operation is promoted as a result of the fact that the molding material, which consists, for example, of a mixture of components with thermoplastic and thermosetting properties, is heated before or during the compression operation.

For this purpose, in previously known processes of the type described at the beginning, a heating medium is introduced into channels provided in the pressing rams and/or the mold frame in order to heat the molding material via the pressing rams and/or the mold frame. Similarly, mold packets used in the plastic injection molding technique are heated with a heating medium, such as a thermal oil, which is introduced into channels located in these mold packets, before injection molding material, which has preferably already been preheated in an extruder, is injected. To remove the molded body from the pressing cavity, the molded body usually has to be cooled again to prevent the pressed material from sticking to the pressing ram or the mold die and to ensure the dimensional stability of the pressed article. For this reason, a coolant is usually introduced into the channels located in the pressing rams and/or the mold die. In addition, in connection with the production of roof tiles, a process is known in which the water contained in the molded body is decomposed by electrolysis for the purpose of using the associated generation of gas on the surfaces of the mold to facilitate the desired separation of the molded body from the surfaces of the mold. However, this process can be used only with the use of molding material that contains water. Therefore, when processes of the type described at the beginning are used, the rate of production is usually limited by the time required to heat and cool the molding material and the pressing rams or the mold frame.

In light of these problems in the state of the art, the object of the invention is to develop a process of the type described at the beginning, which makes it possible to increase the production rate, and to specify equipment for carrying out processes of this type.

In accordance with the invention, this object is achieved by a refinement of the known processes, which is essentially characterized by the fact that the molding material is heated by producing ohmic heat.

This invention goes back to the recognition that the low production rate and the relatively long cycle times in carrying out the previously known processes can be attributed to the indirect heating of the material via the pressing rams or the mold frame. This indirect heating results in an increase in the mass to be heated in the course of the production of the molded body and thus in an increase in the time required for the heating, because it is necessary to heat not only the molding material itself, but also the parts of the mold, such as the pressing rams or the mold frame, to the high temperature that is required, and the high heat capacity of the pressing rams and mold frame, which are usually made of steel, leads to a further increase in the cycle times or a further decrease in the rate of production.

In the process of the invention, the mass to be heated (and later cooled) is limited to the molding material itself and the contact surfaces of the molding material on the pressing rams and the mold frame, because the heating occurs directly in the molding material by the production of ohmic heat, so that heating of the pressing rams and the press frame can basically be eliminated. The cycle times can be significantly reduced in this way. The process of the invention can be carried out, for example, with presses whose pressing cavity is bounded by at least one movable pressing ram. In this regard, it was found to be especially advantageous for the ohmic heat to be produced in the molding material by applying an electric voltage to the molding material via the movable pressing ram.

As is apparent from the above explanation of processes of the invention, equipment that can be used to carry out processes of this type is characterized by the fact that it has an apparatus for applying an electric voltage to the molding material contained in the pressing cavity. In this connection, depending on requirements, the voltage can be applied to the molding compound itself and to the surrounding machine parts both as direct voltage and as alternating voltage.

It is advantageous if the pressing cavity is bounded by a mold frame and a molding die and two press rams that can move into this mold frame in opposite directions from each other, such that each of these pressing rams has at least one electrically conductive contact surface that comes into contact with the molding material during the compression operation, and the ohmic heat is produced by applying a voltage to at least one contact surface of each pressing ram.

In this regard, the pressing cavity should be designed in such a way that, when the electric voltage is applied, current is forced to flow through the molding material, which, although it is electrically conductive, is a much poorer conductor of electricity than metals. This can be effected in such a way that the pressing rams, whose contact surfaces rest against opposite sides of the molding material, are used as contacts for applying the electric voltage to the molding material, while other parts of the mold, such as the mold frame and the molding die, which are in contact with the molding material, are made of a nonconductive material. Alternatively, it is also possible to electrically insulate the mold frame from the pressing rams and to produce it from at least two frame elements, which are arranged one behind the other in the direction of movement of the pressing rams and are electrically insulated from one another, in order to prevent the flow of current through the mold frame, even if the mold frame is made of an electrically conductive material.

In accordance with the invention, it is possible to use pressing rams in which the entire contact area of the pressing ram that comes into contact with the molding material in the course of the compression operation is designed as an electrically conductive contact surface. In regard to achieving the most uniform possible heating of the molding material, it was found to be especially advantageous, especially for the production of molded bodies with highly structured product geometries, such as for the production of products with different thicknesses in the cross section, if the pressing rams have, in addition to the contact surfaces, pressing surfaces made of electrically insulating material, which come into contact with the molding material during the compression operation. In this way, only certain regions of the molding material, which are determined by the geometry of the electrically conductive contact surfaces, are contacted, in order to ensure uniform heat input even in the case of highly structured product geometries.

Again, in regard to achieving the most uniform possible heating of the molding material, it may be advantageous if at least one of the pressing rams has at least two contact surfaces that are insulated from each other, and the voltage generation equipment for producing the ohmic heat comprises at least two current or voltage sources that are separate from each other, each of which is connected with one of the contact surfaces. In this way, two or more separate circuits are formed within the molding material, so that, in the case of a complicated geometry of the molded body, a well-defined power input can be supplied at different points or in different regions of the molded body by suitable regulation of these circuits. In this regard, the contact surfaces can be realized, for example, in the form of conductive tracks formed parallel to the contact surface of the pressing ram in contact with the molding material. Additionally or alternatively, however, the contact surfaces can be realized almost as points in the form of conductors passing through the pressing ram surface that comes into contact with the molding material.

In regard to optimization of the production process, it was also found to be advantageous for the voltage applied to the molding material to be controlled as a function of the position of the pressing rams, the duration of the heat input, the electric current flowing through the molding material, and/or the duration of the compression operation. In this connection, it is possible, for example, to apply a voltage to the contact surfaces of the pressing rams only when both pressing rams have reached the molding material, but before the actual compression, such that the voltage can continue to be applied during the compression or even after compression has been completed. By measurement of the voltage, current, and time, and by control of the voltage generation equipment as a function thereof, the power input into the molding material during the pressing operation can be both measured and systematically controlled or regulated, so that, with known product properties, the same temperature is always achieved in the molded article. This control or regulation can also be supported or checked with one or more temperature sensors. Since the electrical resistance of the molding material varies during the compression operation, it was found to be especially advantageous for the control device used to control the voltage applied to the molding material also to have automatic current limiting, so that a preset maximum current intensity is not exceeded.

The aforementioned variation of the ohmic resistance of the molding material in the course of the compression operation also allows control of the compression operation itself as a function of the current measured at a given voltage during the compression operation, because this current provides a reference point for the density that has been attained in the molded article. By measuring the electric current through the molding material, it is thus possible to control the compression operation to obtain the desired properties of the molded body. In other words, the measurement of the current flowing through the molding material furnishes the user of equipment in accordance with the invention with a characteristic quantity, with which he/she can evaluate the results of the process while the compression operation is still being carried out and can take steps to control the process on the basis of this evaluation.

In an especially advantageous refinement of the invention, it is also possible to apply the voltage, even after completion of the compression operation, to the now completed molded body or even to increase the voltage or possibly to change over from an alternating voltage to a direct voltage to facilitate the release of the molded body from the pressing cavity. Alternatively or additionally, it is also possible, depending on the properties of the molding material, to cool at least one of the pressing rams before, during, and/or after the compression operation, to facilitate the release of the molded body from the pressing cavity. This can be effected, for example, with the use of a cooling liquid circulating through the pressing ram. It is advantageous for this pressing ram to have a channel designed for introducing the cooling liquid.

Another embodiment of the invention involves the use of the heat of vaporization of liquids. A liquid, preferably water, is fed into channels of the pressing ram under atmospheric pressure or reduced pressure, and the heat removed by the evaporation of this liquid is used for cooling.

It is advantageous for the pressing rams of the equipment of the invention, at least in the region of the electrically conductive contact surfaces, to be made of a material that is resistant to electrochemical corrosion, such as CrNi steel, to prevent possible corrosion of the contact surfaces, including long-term corrosion.

Especially in combination with the above-described highly effective heat dissipation systems in the pressing ram, the heating of the molding material by the production of ohmic heat in the molding material in accordance with the invention makes it possible to achieve extremely short hot-cold cycles in the forming process. In particular, the heating by direct flow of current in accordance with the invention makes it possible to operate the cooling system continuously, e.g., by feeding the coolant into the ram, since the heat is produced directly in the molding material and not in the ram. Therefore, with the use of equipment of the invention in the process of the invention, it is possible to carry out hot pressing with cold rams, even when the molding material is in the cold state when introduced between the pressing rams.

The invention is explained below on the basis of the drawing, which is expressly referred to in regard to all details that are essential to the invention and are not set forth in detail in the specification.

The sole figure in the drawing is a schematic representation of equipment in accordance with the invention. The equipment shown in the drawing consists essentially of a mold frame 20, two pressing rams 12 and 14, which can be moved into the mold frame 20 in the directions indicated by the arrows A, and a current source 30 connected to the pressing rams 12 and 14.

To produce a molded body, first the pressing ram 12 is moved into the mold frame 20. The pressing cavity 10, which is formed by the pressing ram 12 and the mold frame 20 and is open at the top, is then filled with molding material. The molding material contained in the pressing cavity 10 is then pressed from above and below by the pressing ram 14, which is driven into the pressing cavity, and the pressing ram 12. During this operation, a voltage is applied to the molding material contained in the pressing cavity 10 by the current source 30 through the pressing rams 12 and 14, which causes heating of the molding material contained in the pressing cavity by the production of ohmic heat in the molding material.

In regard to the fact that the molding material usually has a significantly higher ohmic resistance than the press frame, which is usually made of metal, the press frame of the equipment of the invention is designed with two frame elements arranged one behind the other in the direction of movement of the pressing rams 12 and 14, and a layer of insulating material is placed between the two frame elements. Alternatively, the mold frame can be made of electrically nonconductive material. In this way, current is forced to flow through the molding material, which, although it is electrically conductive, is a much poorer conductor of electricity than a metal. The layer of insulating material 22 is located at about the height of the neutral position within the pressing cavity 10, i.e., at a height at which there is no appreciable displacement of the molding material, but rather it is merely compressed. As was already explained earlier, the pressing operation and the current source 30 can be controlled as a function of the position of the pressing rams 12 and 14, the current generated by the current source 30, the duration of the pressing operation, and/or the duration of the heat generation.

The invention is not limited to the embodiment explained on the basis of the drawing, but rather it is also possible to generate eddy currents in the molding material to achieve especially uniform heating of the molding material by producing ohmic heat in it. In addition, it is also possible to use equipment that has only one movable pressing ram. Furthermore, equipment in accordance with the invention may also include two or more current sources for producing the ohmic heat in the molding material.

1. Process for producing a molded body, in which a preferably powdered, pasty, or granular molding material is heated and compressed in a pressing cavity, characterized by the fact that the molding material is heated in the pressing cavity by the production of ohmic heat.

2. Process in accordance with claim 1, characterized by the fact that the pressing cavity is bounded by at least one movable pressing ram, through which an electric voltage is applied to the molding material for the production of the ohmic heat.

3. Process in accordance with claim 2, characterized by the fact that the pressing cavity is bounded by a mold frame and two movable pressing rams, each of which has at least one electrically conductive contact surface that comes into contact with the molding material during the compression operation, and that a voltage is applied to at least one contact surface of each pressing ram to produce the ohmic heat.

4. Process in accordance with claim 3, characterized by the fact that at least one of the pressing rams has at least two contact surfaces that are insulated from each other, and that, to produce the ohmic heat, at least two separate voltage and/or current sources are provided, each of which is connected to one of the contact surfaces.

5. Process in accordance with any of the preceding claims, characterized by the fact that the voltage applied to the molding material is controlled as a function of the position of the one or more pressing rams, the duration of the heat input, the electric current flowing through the molding material, and/or the duration of the compression operation.

6. Process in accordance with any of the preceding claims, characterized by the fact that the pressing pressure acting on the molding material during the compression is controlled as a function of the electrical resistance of the molding material.

7. Process in accordance with any of the preceding claims, characterized by the fact that, after completion of the compression operation, an electric voltage is applied to the molding material.

8. Process in accordance with any of the preceding claims, characterized by the fact that at least one of the pressing rams is cooled before, during, or after the compression operation.

9. Process in accordance with claim 8, characterized by the fact that a cooling liquid is circulated through the pressing ram to cool it.

10. Process in accordance with claim 8 or claim 9, characterized by the fact that a cooling liquid, preferably water, is fed into channels located in the pressing ram under atmospheric pressure or reduced pressure, and the heat removed by the evaporation of this liquid is used for cooling.

11. Equipment for carrying out a process in accordance with any of the preceding claims, with a pressing cavity (10) for holding molding material and with equipment for compressing the molding material contained in the pressing cavity (10), characterized by equipment for applying an electric voltage to the molding material contained in the pressing cavity (10).

12. Equipment in accordance with claim 11, characterized by the fact that the pressing cavity (10) is bounded by at least one movable pressing ram (12, 14), through which the electric voltage is applied to the molding material.

13. Equipment in accordance with claim 11 or claim 12, characterized by the fact that the pressing cavity (10) is bounded by a mold frame (20) and two pressing rams (12, 14), which preferably can be moved in opposite directions from each other, and each of which has at least one electrically conductive contact surface that comes into contact with the molding material during the compression operation.

14. Equipment in accordance with claim 12 or claim 13, characterized by the fact that at least one of the pressing rams (12, 14) has a pressing surface made of an electrically insulating material, which comes into contact with the molding material during the compression operation.

15. Equipment in accordance with any of claims 12 to 14, characterized by the fact that at least one of the pressing rams (12, 14) has two contact surfaces that are electrically insulated from each other, and the voltage generation equipment has at least two separate voltage and/or current sources, each of which is connected to one of the contact surfaces.

16. Equipment in accordance with any of claims 13 to 15, characterized by the fact that the mold frame (20) is electrically insulated from the pressing rams and has at least two frame elements that are arranged one behind the other in the direction of movement of the pressing rams and are electrically insulated from each other.

17. Equipment in accordance with any of claims 12 to 16, characterized by the fact that at least one of the pressing rams (12, 14) is made of a material that is resistant to electrochemical corrosion, such as CrNi steel, at least in the region of the contact surfaces.

18. Equipment in accordance with any of claims 12 to 17, characterized by the fact that a channel designed for the introduction of a cooling liquid is located in at least one of the pressing rams.

19. Equipment in accordance with any of claims 11 to 18, characterized by the fact that a device for determining the electrical resistance of the molding material contained in the pressing cavity and/or a measuring device for measuring the electric current flowing through the molding material is assigned to the voltage generation equipment.

20. Equipment in accordance with any of claims 11 to 19, characterized by a control device for controlling the compression operation and/or the voltage applied to the molding material as a function of the duration of the heat input, the position of the pressing rams, the electric current flowing through the molding material, the electrical resistance of the molding material, and/or the duration of the compression operation.
